(19) United States
(12) Patent Application Publication
(10) Pub. No.: US 2008/0211454 A1
(43) Pub. Date: Sep. 4, 2008

(54) BATTERY PACK HAVING A SECONDARY BATTERY AND A CHARGING SYSTEM USING THE BATTERY PACK

(75) Inventor: Junji NISHIDA, Osaka (JP)

Correspondence Address: COOPER & DUNHAM, LLP, 1185 AVENUE OF THE AMERICAS, NEW YORK, NY, 10036, US

(73) Assignee: Ricoh Company, Ltd., Tokyo (JP)

(21) Appl. No.: 12/111,721

(22) Filed: Apr. 29, 2008

Related U.S. Application Data
(62) Division of application No. 11/184,162, filed on Jul. 19, 2005.

(30) Foreign Application Priority Data
Jul. 20, 2004 (JP) 2004-211490

(51) Int. Cl. H02J 7/00

(52) U.S. Cl. 320/106; 320/112; 320/137

(57) ABSTRACT

A battery pack including at least one secondary battery and supplying power to predetermined equipment is disclosed. In the battery pack, charging current to the secondary battery supplied from an external charging device is cut oft to suspend charging the secondary battery until receiving a predetermined instruction from the external charging device.

The battery pack may comprise a first communication circuit unit for communicating with the external charging device; a first switching circuit unit for cutting off the charging current from the external charging device to the secondary battery; and a control circuit unit for controlling the first switching circuit unit based on information received by the first communication circuit unit. The control circuit unit instructs the first switching circuit unit to cut off the charging current from the external charging device to the secondary battery and suspend charging the secondary battery until receiving the predetermined instruction from the external charging device via the first communication circuit unit.

### BACKGROUND OF THE INVENTION

1. Field of the Invention

The present invention generally relates to a battery pack having a secondary battery and a charging system using the battery pack, and specifically relates to charging/discharging control of the battery pack containing ID information for identifying the battery pack having the secondary battery.

2. Description of the Related Art

In prior art battery pack charging systems, battery packs have a special shape which can be adapted to a specific charging device, and therefore only specific battery packs can be charged by the specific charging device. However, battery charging capacities are increasing as technology progresses; a newer battery pack having the same shape has a larger charging capacity.

A prior art battery pack charging device always performs the same control for a battery pack attached to the charging device. Accordingly, if a battery pack having the same shape but a larger charging capacity is attached to the prior art battery charging device, it may take a longer time to fully charge the battery pack. On the other hand, if a battery pack having the same shape but a smaller charging capacity is attached to the prior art battery charging device, the battery charging device may supply a charging current larger than rated current to the battery pack and may shorten the battery service life.

In order to solve the problem, the battery pack may have ID information unique to the battery pack, as disclosed in Japanese Patent Publication No. 06-81425. When starting charging the battery pack, a battery charging device may obtain the ID information of the battery pack, and based on the obtained ID information, the battery charging device may receive battery information such as charging capacity to be utilized for charge control.

However, in prior art battery pack charging systems, battery packs have a special shape which can be adapted to a specific charging device. Accordingly, only if a battery pack can be attached to a charging device, the charging operation is automatically started without checking whether proper ID information is obtained. Therefore inadequate charging may be performed resulting in failures of the battery pack and the charging device.

Even if a battery pack has its ID information, in a case where a charging device does not have an ID recognizing function, inadequate charging may be performed resulting in failures or short service lives of the battery pack and the charging device.

Further, when a battery pack is attached to off-specification equipment, or the battery pack is shortened, current larger than specification current may flow resulting in failure of the battery pack.

### SUMMARY OF THE INVENTION

Accordingly, it is a general object of the present invention to provide a battery pack having a secondary battery and a charging system using the battery pack, which can prevent failures of the battery pack and a charging device by preventing improper charging/discharging even if the battery pack is attached to an inadequate charging device.

Features and advantages of the present invention are set forth in the description that follows, and in part will become apparent from the description and the accompanying drawings, or may be learned by practice of the invention according to the teachings provided in the description. Objects as well as other features and advantages of the present invention will be realized and attained by a charging system particularly pointed out in the specification in such full, clear, concise, and exact terms as to enable a person having ordinary skill in the art to practice the invention.

To achieve these and other advantages and in accordance with the purpose of the invention, as embodied and broadly described herein, the invention provides as follows.

According to one feature of the present invention, there is provided a battery pack including at least one secondary battery and supplying power to predetermined equipment, characterized in that charging current to the secondary battery supplied from an external charging device is cut off to suspend charging the secondary battery until receiving a predetermined instruction from the external charging device.

The battery pack may comprise a first communication circuit unit for communicating with the external charging device; a first switching circuit unit for cutting off the charging current from the external charging device to the secondary battery; and a control circuit unit for controlling the first switching circuit unit based on information received by the first communication circuit unit; wherein the control circuit unit instructs the first switching circuit unit to cut off the charging current from the external charging device to the secondary battery and suspend charging the secondary battery until receiving the predetermined instruction from the external charging device via the first communication circuit unit.

According to another feature of the present invention, there is provided a charging system comprising a battery pack including at least one secondary battery, and a charging device for charging the battery pack, characterized in that the charging device communicates with the battery pack in a predetermined manner when receiving a DC power supply for charging the secondary battery, and when the charging device cannot communicate with the battery pack, the charging device suspends charging the secondary battery.

According to embodiments of the present invention, if a battery pack is connected to an inadequate charging device such as an off-standard charging device, it is possible to stop the charging operation. When the battery pack is connected to equipment other than equipment with a proper main body, the charging system allows the secondary battery to discharge but prevents charging of the secondary battery, and therefore it is possible to prevent the failure or short service life of the battery pack.

Under the situation where the charge control circuit cannot communication with the battery pack, cannot obtain any ID information from the battery pack, or determines that the ID information obtained from the battery pack is invalid, the charge control circuit stops the charging current from flowing to the battery pack and instructs the control circuit to prevent charging by having the protection circuit turn off a transistor. However, under the same situation, the charge control circuit can prevent the battery pack from discharging as well as stop the charging current from flowing to the battery pack.

Before starting to charge the battery pack, the charge control circuit checks the ability to communicate with the battery pack. If communication is impossible, the charging of the battery pack is not carried out. If communication is possible, then the charge control circuit determines whether there is ID information for the battery pack. If there is no ID information or invalid information, the charge control circuit prevents charging and discharging since an attached battery pack cannot be properly charged by the main body, and therefore failures due to mismatching between the battery pack and the charging device can be prevented. If the ID information is valid, based on the battery information obtained from the remainder detection circuit of the battery pack, it is possible to select the optimum charging method.

### BRIEF DESCRIPTION OF THE DRAWINGS

Other objects, features, and advantages of the present invention will become apparent from the following detailed description when read in conjunction with the accompanying drawings, in which:

FIG. 1 is a block diagram of a charging system according to an embodiment of the present invention;

FIG. 2 is a flowchart showing an operational procedure of the charging system shown in FIG. 1; and

FIG. 3 is a flowchart showing another operational procedure of the charging system shown in FIG. 1.

### DESCRIPTION OF THE PREFERRED EMBODIMENTS

In the following, embodiments of the present invention are described with reference to the accompanying drawings.

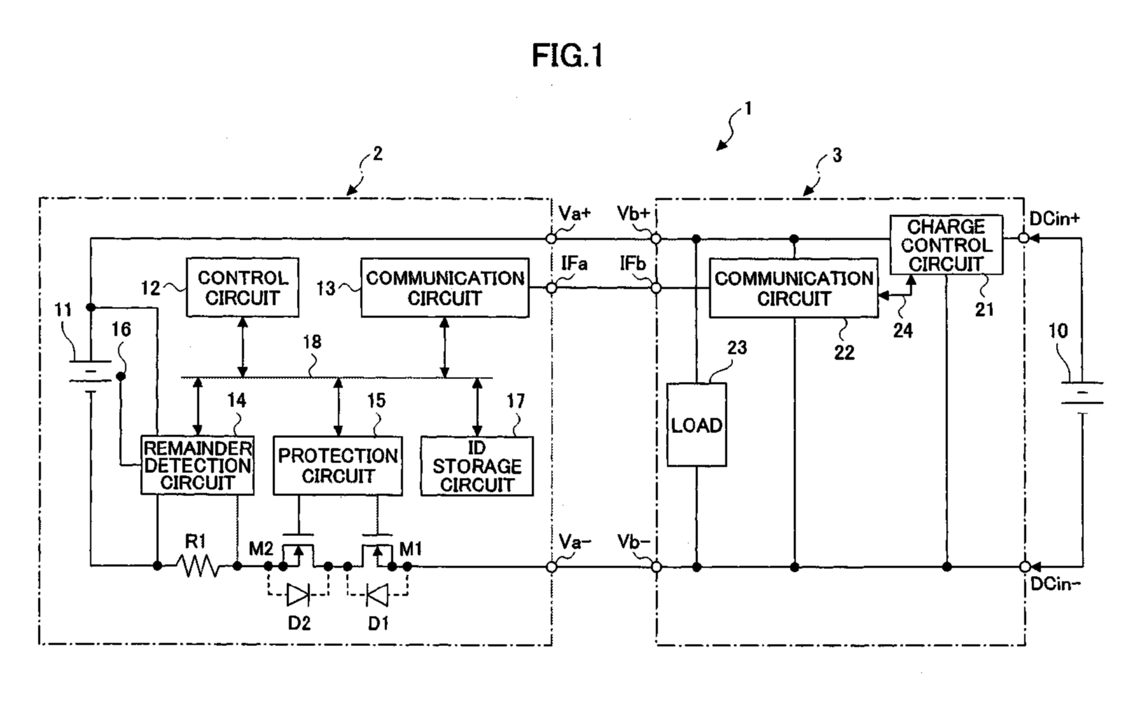

FIG. 1 is a block diagram illustrating a charging system for charging a secondary battery according to an embodiment of the present invention. The charging system includes a battery pack including a secondary battery.

As shown in FIG. 1, the charging system 1 comprises the battery pack 2 including a secondary battery or rechargeable battery 11, and a main body 3 having a function of charging the battery pack 2 and being connected to the battery pack 2 to perform predetermined other functions. A charging DC power supply 10 for charging the battery pack 2 is connected to the main body 3.

The battery pack 2 comprises at least one secondary battery 11 such as a lithium battery, a control circuit 12 for controlling an electronic circuit contained in the battery pack 2, a communication circuit 13 for transmitting and receiving information to and from the main body 3, a remainder detection circuit 14 that measures a charging/recharging current, voltage and temperature of the secondary battery 11 to determine the remaining energy of the secondary battery 11. The battery pack 2 further comprises NMOS transistors M1, M2 and a protection circuit 15. The protection circuit 15 turns off the NMOS transistor M1 to cut a charging current to the secondary battery 11 when it detects any abnormality during the charging period of the secondary battery 11, and turns off the NMOS transistor M2 to cut a discharging current from the secondary battery 11 when it detects any abnormality during the discharging period of the secondary battery 11.

The battery pack 2 further comprises a current detection resistance R1 for detecting a charging/discharging current of the secondary battery 11, a thermometer 16 for measuring a temperature of the secondary battery 11, and an ID storage circuit 17 for storing many pieces of information unique to the battery pack 2. The control circuit 12, the communication circuit 13, the remainder detection circuit 14, the protection circuit 15 and the ID storage circuit 17 are connected to each other via an internal bus 18. The control circuit 12 is an example of the control circuit unit, the communication circuit 13 is an example of the first communication circuit unit, and the remainder detection circuit 14, the thermometer 1E and the resistance R1 are an example of the remainder detection circuit unit. The protection circuit 15 and the NMOS transistor M1 are an example of the first switch circuit unit, and the protection circuit 15 and the NMOS transistor M2 are an example of the second switch circuit unit. The ID storage circuit 17 is an example of the storage circuit unit.

A positive electrode of the secondary battery 11 is connected to a power supply terminal Va+. Between a negative electrode of the secondary battery 11 and a power supply terminal Va−, the resistance R1 and the NMOS transistors M2 and M1 are serially connected. A substrate gate is connected to the NMOS transistor M1 so as to form a parasitic diode D1 in the direction from the power supply terminal Va− to the NMOS transistor M2. A substrate gate is connected to the NMOS transistor M2 so as to form a parasitic diode DZ in the direction from the resistance R1 to the NMOS transistor M1.

The communication circuit 13 is connected to an input/output terminal IFa that is a communication terminal of the battery pack 2. A voltage of the power supply terminal Va+ is input to the remainder detection circuit 14. To the remainder detection circuit 14, the thermometer 16 is connected and a voltage across the resistance R1 is input. The protection circuit 15 controls the switching of the NMOS transistors M1 and M2 in accordance with a control signal input via the internal bus 18 from the control circuit 12. Every circuit in the battery pack 2 has power supplied from the secondary battery 11, although not shown in FIG. 1.

The main body 3 comprises a charge control circuit 21 for controlling the charge to the secondary battery 11 in the battery pack 2, a communication circuit 22 for communicating information with the battery pack 2, and a load 23 having a predetermined function. The charge control circuit 21 and the communication circuit 22 are connected via an internal bus 24. The charge control circuit 21 is connected to power supply terminals Vb+ and Vb− of the main body 3, and connected to a power supply input terming DCin+, to which a positive electrode of the charging DC power supply 10 is connected. The communication circuit 22 is connected to the power supply terminal Vb− and Vb+ of the main body 3, and an input/output terminal IFb that is a communication terminal of the main body 3. The main body 3 is an example of the charging device, the charge control circuit 21 is an example of the charge control circuit unit, and the communication circuit 22 is an example of the second communication circuit unit.

The load 23 is connected to the power supply terminal Vb+ and Vb− of the main body 3. The power supply terminal Vb− of the main body 3 is connected to the power supply input terminal DCin−, to which a negative electrode of the charging DC power supply 10 is connected. When the battery pack 2 is attached to the main body 3, the power supply Va+ of the battery pack 2 is connected to the power supply Vb+ of the main body 3, the power supply va of the battery pack 2 is connected to the power supply Vb− of the main body 3, and the input/output terminal IFa of the battery pack 2 is connected to the input/output terminal IFb of the main body 3.

In this structure, the control circuit 12 detects from the remainder detection circuit 14 that the voltage of the secondary battery 11 is lowered to a predetermined value α. If the control circuit 12 determines that the secondary battery 11 will become over-discharged if the battery continues to discharge, the control circuit 12 instructs the protection circuit 15 to turn off the NMOS transistor M2 to cut the discharging current from the secondary battery 11 and prevent it from becoming over-discharged. When the control circuit 12 determines from the remainder detection circuit 14 that the voltage of the secondary battery 11 is not lowered to the predetermined value α, the control circuit 12 instructs the protection circuit 15 to keep the NMOS transistor M2 on. This controlling operation for the NMOS transistor M2 is carried out even while the communication circuit 13 cannot communicate with the main body because the battery pack 2 is not connected to the main body 3 and the battery pack 2 is connected to other inadequate equipment instead of the main body 3, with which the communication circuit 13 cannot perform normal communication.

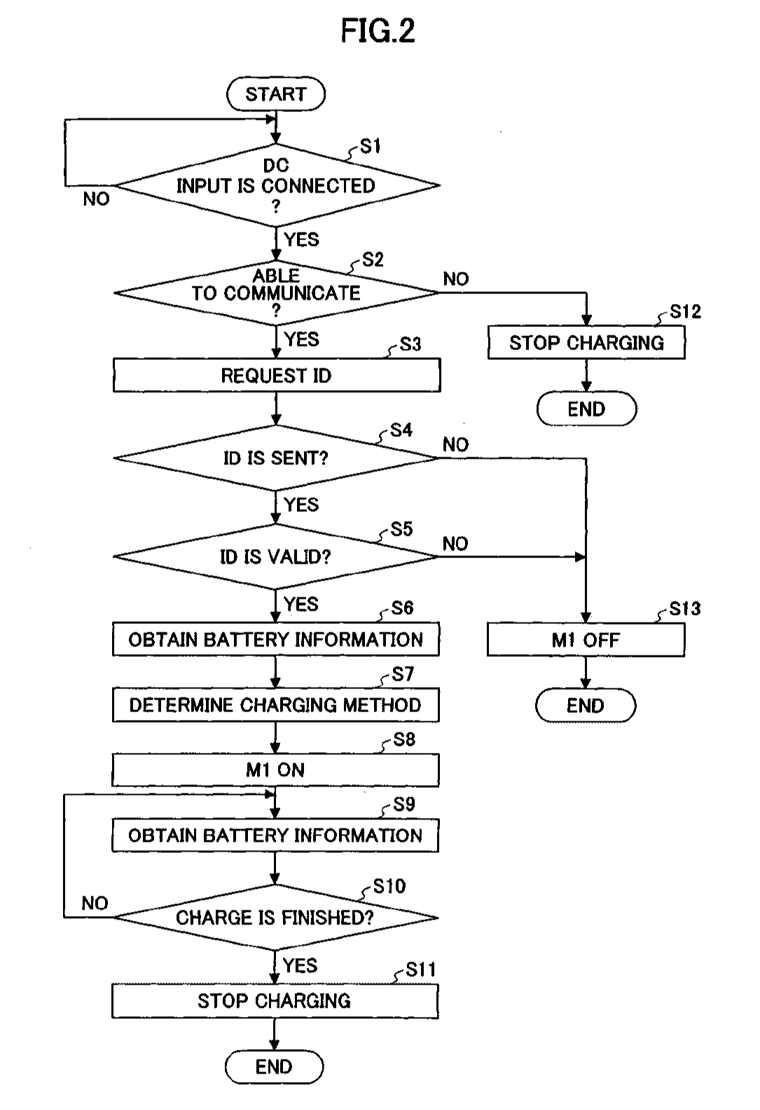

FIG. 2 is a flowchart illustrating a charging operation procedure of the charging system shown in FIG. 1. The charging operation of the charging system 1 is explained below with reference to FIG. 2.

As shown in FIG. 2, after the procedure starts, the charge control circuit 21 first detects whether the charging DC power supply 10 is connected to the power supply input terminals DCin+ and DCin− at step S1. If the charge control circuit 21 does not detect that the charging DC power supply 10 is connected (NO), the charge control circuit 21 continues the detecting operation. On the other hand, if the charge control circuit 21 detects that the charging DC power supply 10 is connected (YES), the charge control circuit 21 determines whether the communication circuit 21 can communicate with the battery pack 2 at step S2. At step S2, if the communication circuit 22 cannot communicate with the battery pack 2 (NO), it is most likely that the battery pack 2 is not connected or an off-specification battery pack is connected. Then the charge control circuit 21 stops charging the battery pack 2 at step S12 and the procedure ends.

If the communication circuit 22 can communicate with the battery pack 2 at step S2 (YES), the charge control circuit 21 communicates with the battery pack 2 via the communication circuit 22, and requests the battery pack 2 to send its ID information at step S3. Next, the charge control circuit 21 determines whether ID information is sent from the battery back 2 at step S4. If no ID information is sent from the battery pack 2 (NO), the procedure goes to step S13, which is explained below. If the charge control circuit 21 receives the ID information from the battery pack 2 (YES), the charge control circuit determines whether the received ID information is valid at step S5.

Next, the operation of the battery pack 2 when the charge control circuit 21 requests ID information is explained. The charge control circuit 21 requests the battery pack 2 via the communication circuit 22 to send ID information, and the request is received at the communication circuit 13 of the battery pack 2 and sent via the internal bus 18 to the control circuit 12. In accordance with the request for ID information from the charge control circuit 21, the control circuit 12 reads out ID information from the ID information storage circuit 17 via the internal bus 18, and sends the read ID information to the communication circuit 22 via the internal bus 18 and the communication circuit 13. The communication circuit 22 sends the received ID information to the charge control circuit 21.

If the charge control circuit 21 determines that the received ID information is invalid at step S5 (NO), the procedure goes to step S13, which is explained below. On the other hand, if the charge control circuit 21 determines that the received ID information is valid (YES), the charge control circuit 21 obtains battery information from the battery pack 2 via the communication circuit 13 and the communication circuit 22 at step S6. The battery information includes the ID information stored in the ID information circuit 17 and a voltage, temperature, current and remaining amount (energy) of the secondary battery 11 detected by the remainder detection circuit 14. Next, the charge control circuit 21 analyzes the battery information obtained from the battery pack 2, and determines a charging method at step S7. In more specifically, based on the full capacity and the present remaining amount (energy) of the secondary battery 11, the charge control circuit 21 determines a charging specification, for example, selects either constant current charging or constant voltage charging, and determines how much current to use when selecting the constant current charging method.

After the charge control circuit 21 determines the charging method, the charge control circuit 21 supplies the charging current to the secondary battery 11 of the battery pack 2, and sends a charge allowance instruction to the battery pack 2 via the communication circuit 22 and the communication 13. The control circuit 12 receives the charge allowance instruction and instructs the protection circuit 15 to turn on the NMOS transistor M1 at step S8. At this timing, the charging of the secondary battery 11 starts. During the charging of the secondary battery 11, the charge control circuit 21 obtains necessary battery information of the secondary battery 11 one item after another from the control circuit 12 via the communication circuit 13 and the communication circuit 22 at step S9. Thereafter, based on the obtained battery information, the charge control circuit 21 determines whether the charge is finished at step S10. If the charge is finished (YES), the charge control circuit 21 stops the charging current supplied to the battery pack 2 at step S11 and the procedure ends. On the other hand, if the charge is not finished yet (NO), the procedure goes back to step S9.

If there is no ID information at step S4 (NO), or the obtained ID information is invalid (NO) at step S5 (NO), the charge control circuit 21 stops the charging current supplied to the battery pack 2 and instructs the battery pack 2 to prevent the charging. The control circuit 12 receives the instruction and instructs the protection circuit 15 to turn off the transistor M1 so as not to allow the charging current to flow to the secondary battery 11 at step S13, and the procedure ends.

In this case, since the charge control circuit 21 and an attached battery pack 2 can communicate with each other (YES at step S2), the attached battery pack 2 may be a standard one but may be out of order. Therefore, in order to prevent causing an inconvenient situation, the NMOS transistor M1 is turned off. In order to turn off the transistor M1, the charge control circuit 21 instructs the control circuit 12 via the communication circuit 22 and the communication circuit 13, to have the protection circuit 15 turn off the transistor M1. Then the procedure ends.

When the communication circuit 13 cannot perform communication such as where the battery pack 2 is not connected to the main body 3 or is connected to inadequate equipment, the protection circuit 15, based on the instruction from the control circuit 12, turns off the transistor M2. If the battery pack 2 is connected to an inadequate charging device, the protection circuit 15, based on the instruction from the charging device, turns off the transistor M1. In this manner, it is possible to stop the charging operation when the battery pack 2 is connected to an off-standard charging device. When the battery pack 2 is connected to equipment other than the main body 3, this system allows the secondary battery 11 to discharge but prevents charging of the secondary battery 11, and therefore it is possible to prevent the failure or short service life of the battery pack 2.

In the above embodiment, under the situation where the charge control circuit 21 cannot communication with the battery pack 2, cannot obtain any ID information from the battery pack 2, or determines that the ID information obtained from the battery pack 2 is invalid, the charge control circuit 21 stops the charging current to the battery pack 2 and instructs the control circuit 12 to prevent charging by having the protection circuit 15 turn off the transistor M1. However, under the same situation, the charge control circuit 21 can prevent the battery pack 2 from discharging as well as stopping the charging current from flowing to the battery pack 2. In this case, the charge control circuit 21 instructs the control circuit 12 to prevent charging and discharging by turning off the NMOS transistors M1 and M2, as well as stopping the charging current from flowing to the battery pack 2.

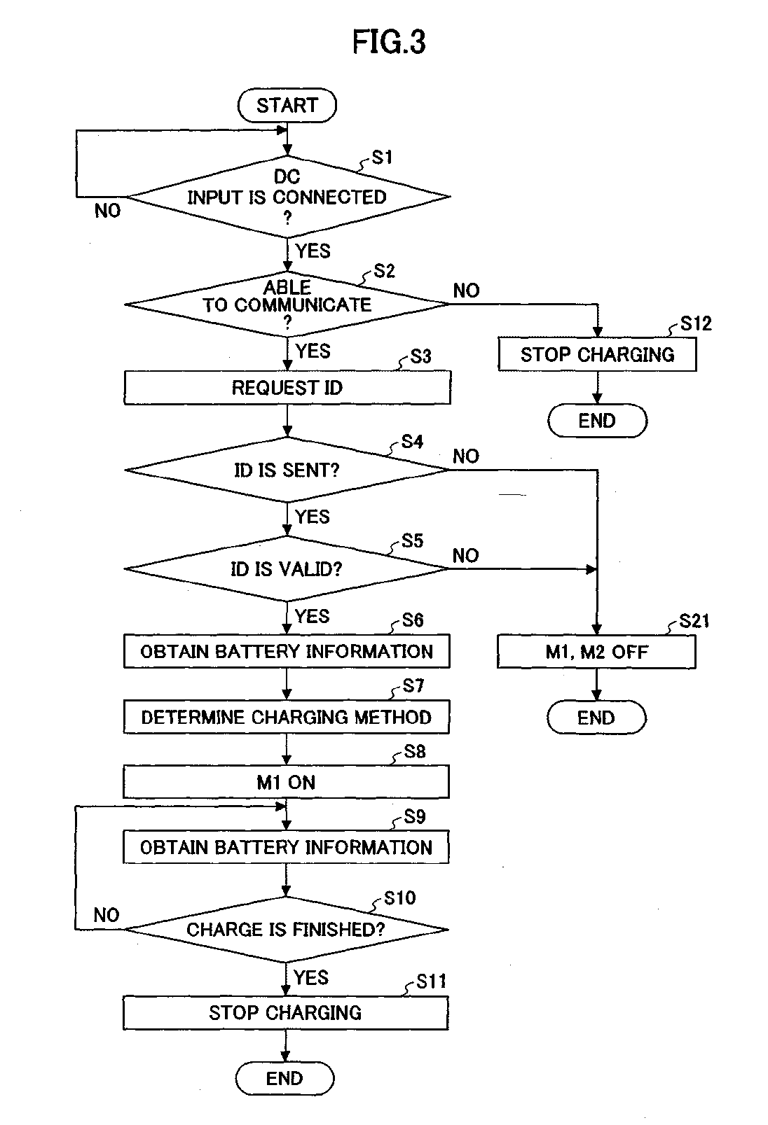

In this case, the procedure becomes that shown in FIG. 3. In FIG. 3, the same or similar steps are assigned the same reference numerals as in FIG. 2, and their explanations are omitted here.

FIG. 3 is different from FIG. 2 in that step 13 in FIG. 2 is replaced with step 21 in FIG. 3.

In the procedure shown in FIG. 3, if there is no ID information at step S4 or the obtained ID information is invalid at step S5, the charge control circuit 21 stops the charging current to the battery pack 2 and instructs the battery pack 2 to prevent charging and discharging. The control circuit 12 receives the instruction, and causes the protection circuit 15 to turn off the NMOS transistors M1 and M2 to prevent the charging current from flowing to the secondary battery 11 and discharging current from flowing from the secondary battery 11. Then the procedure ends.

In this case, since the charge control circuit 21 and an attached battery pack 2 can communicate with each other (YES at step S2), the attached battery pack 2 may be a standard one but may be out of order. Therefore, in order to prevent causing an inconvenient situation, the NMOS transistors M1 and M2 are turned off. In order to turn off the transistors M1 and M2, the charge control circuit 21 instructs the control circuit 12 via the communication circuit 22 and the communication circuit 13, to have the protection circuit 15 turn off the transistors M1 and M2. Then the procedure ends.

In this manner, before starting to charge the battery pack 2, the charge control circuit 21 checks the ability to communicate with the battery pack 2. If communication is impossible, charging to the battery pack 2 is not carried out. If communication is possible, then the charge control circuit 21 checks for ID information for the battery pack 2. If there is no ID information or invalid information, the charge control circuit 21 prevents charging and discharging since the attached battery pack 2 cannot be properly charged by the main body 3, and therefore failures due to mismatching between the battery pack and the charging device can be prevented. If the ID information is valid, based on the battery information obtained from the remainder detection circuit 14 of the battery pack 2, it is possible to select the optimum charging method.

The present invention is not limited to these embodiments, but variations and modifications may be made without departing from the scope of the present invention.

The present application is based on Japanese Priority Application No. 2004-211490 filed on Jul. 20, 2004 with the Japanese Patent Office, the entire contents of which are hereby incorporated by reference.

1-10. (canceled)

11. A charging system comprising:
a battery pack including at least one secondary battery; and
a charging device for charging the battery pack; wherein the charging device communicates with the battery pack in a predetermined manner when receiving a DC power supply for charging the secondary battery, and
when the charging device cannot communicate with the battery pack, the charging device suspends charging the secondary battery.

12. The charging system as claimed in claim 11, wherein
when the charging device can communicate with the battery pack, the charging device reads out predetermined ID information from the battery pack through the communication, and
when the charging device cannot read out the ID information or the charging device determines that the read ID information is invalid, the charging device instructs the battery pack to stop charging the secondary battery, and the battery pack receives the stop charging instruction and cuts off the charging current to the secondary battery and suspends charging the secondary battery.

13. The charging system as claimed in claim 12, wherein when the stop charging instruction is input, the battery pack prevents the secondary battery from discharging to the outside.

14. The charging system as claimed in claim 12, wherein the battery pack comprises:
a first communication circuit unit for communicating with the charging device;
a first switching circuit unit for cutting off the charging current from the charging device to the secondary battery; and
a control circuit unit for controlling the first switching circuit unit based on information received by the first communication circuit unit; and wherein
the control circuit unit instructs the first switching circuit unit to cut off the charging current from the charging device to the secondary battery and suspend charging the secondary battery until receiving a predetermined instruction from the charging device via the first communication circuit unit.

15. The charging system as claimed in claim 14, wherein the control circuit unit instructs the first switching circuit unit to allow the charging current from the charging device to flow to the secondary battery and charge the secondary battery when receiving the predetermined instruction from the charging device via the first communication circuit unit.

16. The charging system as claimed in claim 14, wherein the battery pack comprises:
a second switching circuit unit for cutting off the discharging current from the secondary battery;
and wherein the control circuit unit instructs the second switching circuit unit to cut off the discharging current from the secondary battery and suspend power being supplied to the outside until receiving the predetermined instruction from the charging device via the first communication circuit unit.

17. The charging system as claimed in claim 16, wherein the control circuit unit instructs the second switching circuit unit to allow the discharging current from the secondary battery to flow to supply power to the outside when receiving the predetermined instruction from the charging device via the first communication circuit unit.

18. The charging system as claimed in claim 14, wherein the battery pack comprises:
a storage circuit unit for storing predetermined information; and wherein
in response to a request for the predetermined information from the charging device, the control circuit unit reads out the predetermined information from the storage circuit unit and sends the predetermined information via the first communication circuit unit.

19. The charging system as claimed in claim 18, wherein the predetermined information is ID information unique to the battery pack.

20. The charging system as claimed in claim 14, wherein the battery pack further comprises:
a remainder detection circuit unit for detecting a remaining energy amount of the secondary battery and outputs the detected remaining energy amount to the control circuit unit; and wherein
the remainder detection circuit unit obtains at least voltage information, charging/discharging current information and temperature information of the secondary battery.

21. The charging system as claimed in claim 20, wherein in response to a request from the charging device, the control circuit unit sends the information obtained by the remainder detection circuit unit to the charging device via the first communication circuit unit.

22. The charging system as claimed in claim 14, wherein the charging device comprises:
a second communication circuit unit for communicating with the first communication circuit unit of the battery pack; and
a charge control circuit unit for controlling the charge of the battery pack; and wherein
the charge control circuit communicates with the battery pack via the second communication circuit unit when a charging DC power supply is supplied, and
the charge control circuit unit suspends charging the battery pack when the communication cannot be normally carried out.

23. The charging system as claimed in claim 22, wherein
the charge control circuit unit communicates with the control circuit unit of the battery pack via the first communication circuit unit and the second communication unit, and
in response to a request for the predetermined ID information, when the charge control circuit unit determines that the ID information cannot be obtained from the control circuit unit or the ID information obtained from the control circuit unit is invalid, the charge control circuit unit instructs the control circuit unit of the battery pack to have the first switching circuit unit cut off the charging current to the secondary battery.

24. The charging system as claimed in claim 23, wherein
in response to the request for the predetermined ID information, when the charge control circuit unit determines that the ID information cannot be obtained from the control circuit unit or the ID information obtained from the control circuit unit is invalid, the charge control circuit unit instructs the control circuit unit of the battery pack to have the second switching circuit unit cut off the discharging current from the secondary battery.

25. The charging system as claimed in claim 23, wherein
in response to the request for the predetermined ID information, when the charge control circuit unit determines that the ID information obtained from the control circuit unit is valid, the charge control circuit unit instructs the control circuit unit of the battery pack to control the first switching circuit unit so as to allow the charging current to flow to the secondary battery.

26. The charging system as claimed in claim 25, wherein
in response to the request for the predetermined ID information, when the charge control circuit unit determines that the ID information obtained from the control circuit unit is valid, the charge control circuit unit instructs the control circuit unit of the battery pack to control the second switching circuit unit so as to allow the discharging current to flow from the secondary battery.

27. A method for charging a battery pack having at least one secondary battery supplying power to predetermined equipment, said method comprising the step of:
cutting off charging current to the secondary battery supplied from an external charging device to suspend charging the secondary battery until receiving a predetermined instruction from the external charging device.

28. The method as claimed in claim 27, further comprising the step of:
cutting off discharging current from the secondary battery to the outside until receiving the predetermined instruction from the external charging device.

29. A charging method in a charging system comprising a battery pack including at least one secondary battery, and a charging device for charging the battery pack, said method comprising the steps of:
communicating by the charging device, with the battery pack in a predetermined manner when the charging device receives a DC power supply for charging the secondary battery; and
suspending by the charging device, charging the secondary battery when the charging device cannot communicate with the battery pack.

30. The charging method as claimed in claim 29, further comprising the steps of:
reading out by the charging device, predetermined ID information from the battery pack, when the charging device can communicate with the battery pack, and
when the charging device cannot read out the ID information or the charging device determines that the read ID information is invalid, instructing by the charging device, the battery pack to stop charging the secondary battery and causing the battery pack to cut off the charging current to the secondary battery and suspend charging the secondary battery.

31. The charging method as claimed in claim 30, further comprising the step of:
when the stop charging instruction is input, preventing by the battery pack, the secondary battery from discharging to the outside.
